(19) United States
(12) Patent Application Publication
(10) Pub. No.: US 2003/0090161 A1
(43) Pub. Date: May 15, 2003

(54) Light communication channel-based electronics power distribution system

(76) Inventors: C. Allen Marlow, Saline, MI (US); Zhong-You Shi, Ann Arbor, MI (US)

Correspondence Address: BRINKS HOFER GILSON & LIONE, P.O. BOX 10395, CHICAGO, IL, 60610, US

(21) Appl. No.: 10/271,401

(22) Filed: Oct. 15, 2002

Related U.S. Application Data
(60) Provisional application No. 60/330,306, filed on Oct. 19, 2001.

(51) Int. Cl. H02B 1/24; H01H 35/00

(52) U.S. Cl. 307/149; 307/117; 398/171

(57) ABSTRACT

A central power source and method for distributing power to at least one sensor and/or actuators connected to or integrated in an LCC. In an aspect of the invention, a power distribution system is provided comprising a power source, at least one sensor, an LCC structure, and at least one routing means for directing the energy through the LCC structure. In another aspect, the at least one sensor is connected to an LCC bus connected to an electronic system. In still another aspect, an energy storage means for storing the energy received by the at least one sensor is provided. The invention is also directed to a method for distributing power comprising transmitting energy using a power source, directing the energy through an LCC structure, and receiving the energy from the power source using the at least one sensor.

This application claims the benefit of a U.S. Provisional Application No. 60/330,306 filed on Oct. 19, 2001, the entirety of which is incorporated herein.

### FIELD OF THE INVENTION

The invention generally relates to an electronics power distribution system and a method for distributing power to components of an electronic system. In particular, the invention relates to an electronics power distribution system that uses a light communication channel to distribute power to several sensors.

### BACKGROUND OF THE INVENTION

One of the major issues involving electronic systems is how to efficiently transfer or distribute power to these systems. Typically, round wires and other electrical connectors are used to distribute power to electronic systems. However, traditional wired systems are usually difficult to assemble and the number of wires required for assembly reduces their reliability. In addition, signals passing through wires often cause cross talking and interference with the signal transmission in adjacent wires. Moreover, signals passing through wires cause electromagnetic interference in adjacent wires unless some type of shielding is used. These interferences distort or skew the signals.

Various other systems for supplying power to electrical circuits or components that uses fiber optic cables and one or more light sources and detectors have been described in the art. But while optical fibers are sometimes used in place of wires or incorporated in a molded structure, the use of optical fibers increases the cost of an electronic system. Additionally, integration of optical and electrical components is not ideally suited for high volume manufacturing because of difficulties in assembly.

### BRIEF SUMMARY OF THE INVENTION

The invention uses a central power source using a novel light communication channel (LCC) to transmit electromagnetic energy (e.g., infrared (IR) light, visible, or ultraviolet light) to sensors and actuators located around or within the LCC or the LCC structure. Preferably, the LCC is made of optically transparent or translucent materials such as polybutylene terephthalate, polyethylene terephthalate, or polycarbonate. Preferably, the LCC is in the form of a sheet, but other shapes may be used.

In an aspect of the invention, a power distribution system is provided that comprises a power source, at least one sensor that receives energy from the power source, an LCC structure that transmits the energy from the power source to the at least one sensor, and at least one routing means for directing the energy through the LCC structure from the power source to the at least one sensor.

In another aspect of the invention, a power distribution system is provided comprising a power source, at least one sensor that receives energy from the power source, an LCC structure comprising a polymer, and at least one routing means for directing the energy through the LCC structure from the power source to the at least one sensor. The LCC structure transmits the energy from the power source to the at least one sensor, wherein the at least one sensor is connected to an LCC bus which in turn is connected to an electronic system.

In still another aspect of the invention, a power distribution system is provided that comprises a power source, at least one sensor that receives energy from the power source, an LCC structure, and at least one routing means for directing the energy through the LCC structure from the power source to the at least one sensor, and an energy storage means for storing the energy received by the at least one sensor. The LCC structure transmits the energy from the power source to the at least one sensor, which is connected to an LCC bus which in turn is connected to an electronic system.

The invention is also directed to a method for distributing power comprising transmitting energy using a power source, directing the energy through an LCC structure from the power source to the at least one sensor, and receiving the energy from the power source that propagates through the LCC structure using the at least one sensor. In another aspect, a method for distributing power is provided comprising receiving the energy from the power source that propagated through the LCC structure using the at least one sensor, wherein the at least one sensor is connected to an LCC bus which in turn is connected to an electronic system. In still another aspect of the invention, a method for distributing power is provided comprising storing the energy received by the at least one sensor using an energy-storage means, wherein the at least one sensor is connected to an LCC bus which in turn is connected to an electronic system.

The light from the energy source may be directed to different sensors through the LCC structure using a routing element such as a prism, lens, mirror, beam splitters, or combinations of different optical elements. The sensors that receive the signal or energy from the central source preferably have photovoltaic receptors that convert light into electricity, which may be stored as needed in a capacitor. The stored energy may then be used to power the sensors. Preferably, the sensors have built-in smarts to allow them to send requests for additional power from a power source if they begin to run low. The sensors can also transmit their data through a primary LCC bus, thus allowing the distribution of power without using wires or other electrical connectors.

The LCC structure can be used to direct light towards at least one sensor. If necessary, multiple power sources that generate different wavelengths may be used to power different sensors that have photoreceptors that are sensitive to those wavelengths. The power distribution system may be used in systems such as an instrument panel or an on-engine system to transmit power to various sensors, actuators, and other devices.

### BRIEF DESCRIPTION OF SEVERAL VIEWS OF THE DRAWINGS

FIG. 1 shows a perspective view of an LCC-based electronic system.

FIG. 2 shows another perspective view of an LCC-based electronic system.

FIG. 3 depicts an embodiment of a power distribution system that includes an Integrated Powertrain Control System (IPCS).

FIG. 4 represents a perspective view of an LCC-based electronic system that includes a power source. 1

FIG. 5 represents a cutaway view of an LCC-based electronic system that includes multiple power sources.

FIG. 6 represents a perspective view of an LCC-based electronic system that includes a power source.

### DETAILED DESCRIPTION OF THE INVENTION

An LCC, otherwise known as light communication channel, is a structure made of at least one type of light-transmissive material formed into any shape that would allow transmission of a signal in the form of light from one point to another. An LCC is described in more detail below, but one of its characteristics is that it can be used as a substrate, such as an optical substrate, that can be formed into various shapes such as a rectangular slab or the shape of a part or the entirety of, for example, a main frame of an instrument panel display. As such, it can be used as a primary or secondary transmission means for a signal, such as an optical signal propagating from at least one signal source to at least one signal receiver. An LCC may encompass various electronic and/or optical components to allow a signal, such as an optical signal, to be directed to various electronic and/or optical components within the substrate without having to resort to the use of conventional signal focusing means such as a beam splitter or focusing lens. An LCC may also assume other shapes such as a ring, strand, sheet, or ribbon.

As used herein, an LCC structure refers to an LCC in the form of strands or other structural shapes. An LCC structure also includes an LCC connected or fabricated with at least one components or systems such as a detector, light source, or an electronic system.

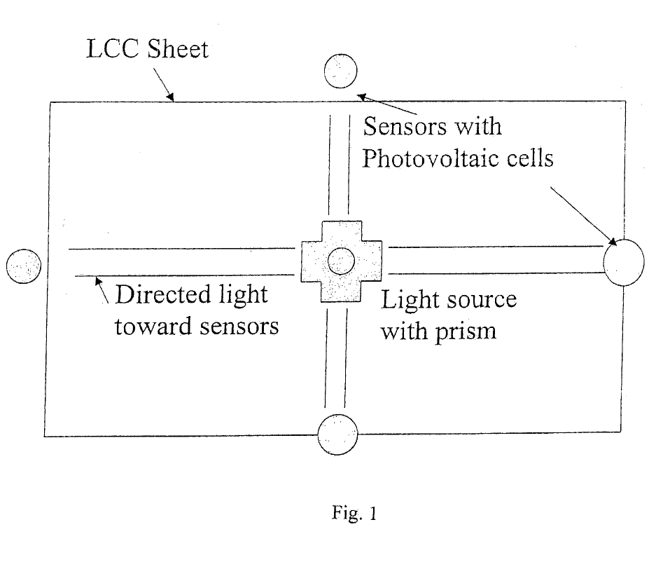

FIG. 1 represents a perspective view of an electronic system that includes an LCC structure 100. This embodiment includes a central power source 102, sensors 104, 106, 108, 110, and an LCC structure 100. The central power source 102 can be a visible, ultraviolet, IR, or other light source, or it can be an RF source. Preferably, the power source 102 is a laser or an LED. The sensors 104, 106, 108, 110 may be embedded within or attached to the LCC structure 100. An emitted signal or energy from the central power source 102 may be directed to the sensors 104, 106, 108, 110 via the LCC structure 100 using a routing or transmission means 112 such as a prism, lens, beam splitter, mirror, or various combinations of routing elements.

The sensors 104, 106, 108, 110 preferably have at least one photovoltaic receptors that convert light energy into electrical energy. The electrical energy may then be used to power the sensors 104, 106, 108, 110. In one aspect, the electrical energy is stored in a capacitor and used as needed.

The sensors are preferably embedded within the LCC or attached to it. In one aspect of the invention, an emitted signal or energy from the central power source may be directed to the sensors via a routing means such as a prism, lens, or mirror through the LCC.

Power sources that produce energies corresponding to different wavelengths may be used to power different sensors that have photoreceptors sensitive to certain wavelengths. Further narrowing of a wavelength range may be performed using at least one optic element such as bandpass filter.

Data obtained from the sensors may be transmitted through a main LCC bus using a light signal, such as an IR signal, to an electronic system such as an electronic controller for further data processing. The power distribution system may be used in an instrument panel, on-engine system, or other devices that require power distribution to the sensors.

Preferably, the LCC structure 100 comprises a polymeric material. The material comprising the LCC structure 100 may be polybutylene terephthalate, polyethylene terephthalate, polypropylene, polyethylene, polyisobutylene, polyacrylonitrile, poly(vinyl chloride), poly(methyl methacrylate), silica, or polycarbonate. Preferably, the polymeric material is a photorefractive polymer.

The polymeric material that channels a signal such as light may be connected to or manufactured as part of engine structures such as intake manifolds. Information obtained from the sensors that relates to monitored parameters may be routed through the LCC structure 100 to at least one electronic systems such as process control electronics.

Preferably, the LCC structure material is made of at least one materials that permit transmission of light of various wavelengths. Thus, for example, the LCC structure 100 may comprise a first material transparent or translucent to a first frequency of the signals and a second material transparent or translucent to a second frequency of the signals.

The LCC structure 100 may have various configurations. Thus, the LCC structure may be flat, curvilinear, wavy, or asymmetrical. The LCC structure 100 may also have various dimensions including non-uniform thickness, diameter, width, and length. The LCC may be fabricated using a moldable material such that the LCC may be cast and then cured to a desired shape. The LCC structure 100 may have parts or areas that are connected, molded, or pressed onto a surface of a circuit board. The LCC structure 100 can be integrated with or with structures such as printed circuit boards, flexible substrates, flatwire, and MID circuits.

The LCC structure 100 may be coated with a reflective material. Preferably, the coatings minimize energy loss by reducing the intensity of the optical signal transmitted out of the LCC.

The LCC structure 100 may have a reflective coating on at least one of its surfaces. In one aspect of the invention, the reflective coating covers the entire surface or substantially the entire surface of the LCC structure except for the portions of the surface where the power source 102 and sensors 104, 106, 108, 110 are operatively connected to the LCC structure 100. Alternatively, the reflective coating covers at least one surface of the LCC structure 100. The reflective coating may be used to, for example, cover only the surface of the LCC structure 100 that substantially encompass a volume of the LCC through which energy from the power source 102 is transmitted to the sensors 104, 106, 108, 110.

The reflective coating may comprise any material that reflects the energy transmitted through the LCC structure 100. The reflective coating may also comprise at least one metal or metallic alloy containing metals such as aluminum, copper, silver, or gold. The LCC structure 100 may have a different refractive index from that of the reflective coating. Preferably, the LCC structure 100 has a higher refractive index than the reflective coating.

Preferably, the power source or emitter 102 is a light source. An example of a preferred light source is an infrared light source. However, the signals may have any electromagnetic frequency capable of transmission through the LCC structure 100 and communication between the power source 102 and the sensors 104, 106, 108, 110. The signal being transmitted may be a combination of electromagnetic frequencies. The power source 102 includes, but is not limited to, an LED, a laser, or an RF source. The laser may emit IR, visible, or ultraviolet light.

Preferably, at least one power source 102 transmits a signal through the LCC structure 100. A signal may be directed to any or various directions within the LCC structure 100, unless the power source or another component blocks the signal or a surface of the LCC structure 100 reflects the signal. The energy may propagate, sequentially or simulataneously, along the same or opposite directions. The sensors 104, 106, 108, 110 may be positioned in any suitable location on a surface of the LCC structure 100 where the sensors can receive at least one energy form from at least one power source. Multiple sensors may receive energy from a single power source.

In one aspect of the invention, the power source 102 and sensors 104, 106, 108, 110 are operatively connected to at least one surface or end of the LCC structure 100. The power source 102 and each sensor 104, 106, 108, 110 may be on the same or different surfaces of the LCC structure 100. “Operatively connected” refers to the formation of an optical, electrical, or other interface for transmitting and receiving the signals through the LCC structure 100. Being “operatively connected” also means that attachment configurations, attachment substances, other attachment mechanisms, or a combination of attachment materials or mechanisms affix the power source 102 and the sensors 104, 106, 108, 110 onto the LCC structure 100. The attachment configurations include physical adaptations of the LCC structure 100 such as an indentation or a pressure fit structure. Attachment substances include, but are not limited to, adhesives, resins, and solder.

Preferably, the power source 102 transmits a signal in the form of light energy to at least one of the sensors 104, 106, 108, 110 via the LCC structure 100. In particular, the power source 102 may transmit at least one signals in response to an input signal from an electronic system such as a process control electronics. The power source 102 may transmit at least one signals which may be pulsed, continuous, or a combination of pulsed and continuous signals.

The power source 102 is preferably an electromagnetic radiation generation device. Preferably, each power source 102 is a light generation device such as a laser or a light emitting diode (LED). Alternatively, each power source is a radio frequency (RF) generation device such as an RF transmitter. For example, a first power source may be an electromagnetic radiation generation device such as a LED or a laser and a second power source may be an RF transmitter.

A power source 102 and at least one sensor 104, 106, 108, 110 may be integrated with a component such as an RF transceiver, which may transmit a first signal at a given time and receive a second signal at another time. The first and second signals may have the same or different frequencies. The sensor may include both a detector and another component such as a capacitor where the collected energy may be stored.

Signals such as optical signals from optoelectronic transmitters can be channeled or transported through air to reach their destination if there are no obstacles in their path of travel. The transmitters preferably generate a unique wavelength of a light signal. In an aspect of the invention, a wavelength selective filter is placed in front of the sensor so little or no interference occurs between different transmitters and sensors.

As used herein, a “sensor” refers to a device that receives a signal or energy from a signal or power source. The signal received by a sensor may be a light signal. Thus, a sensor may include at least one component such as a photodetector or both a photodetector and a capacitor. In particular, at least one of the sensors 104, 106, 108, 110 may include an electromagnetic radiation reception or collection device such as a photodiode or an RF sensor. The sensors 104, 106, 108, 110 include, but are not limited to, photodiodes, microchannel plates, photomultiplier tubes, or a combination of sensors. The sensors 104, 106, 108, 110 may receive or collect at least one signal through the LCC structure 100. In one aspect of the invention, the sensors 104, 106, 108, 110 provide an output signal to the electronic system in response to a signal that propagates through the LCC structure 100. The sensors 104, 106, 108, 110 preferably have at least one frequency specific filters to reduce or eliminate interference from signals with certain frequencies or frequency ranges.

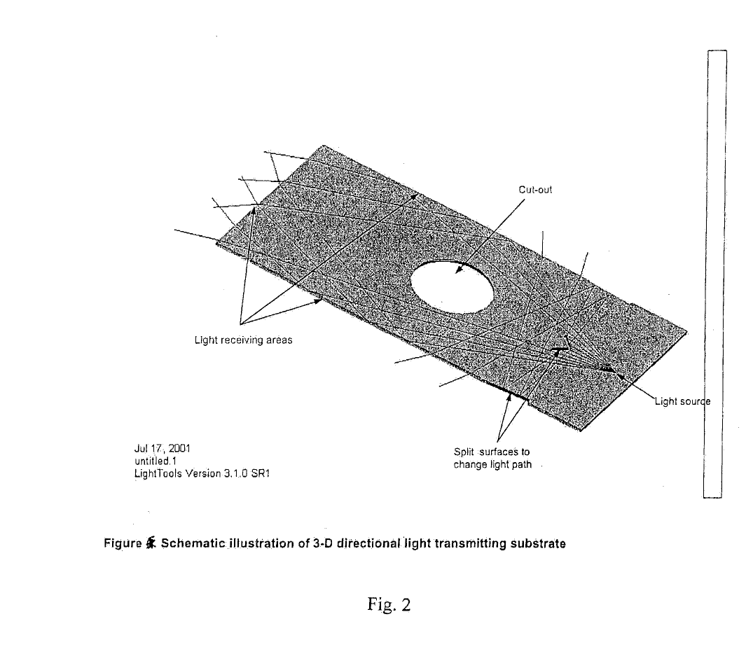

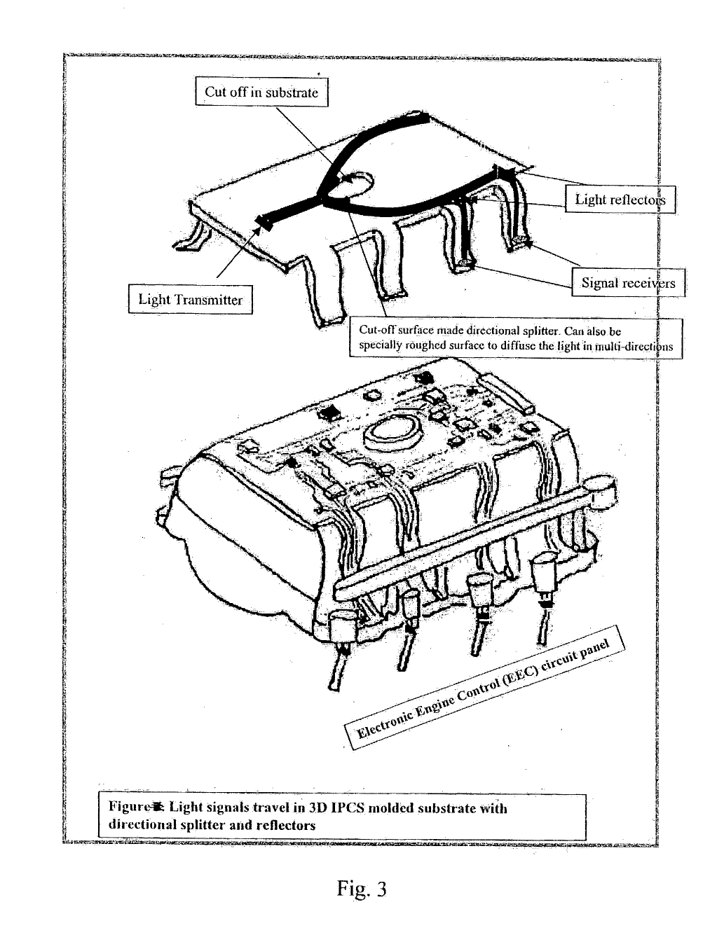

FIGS. 2 and 3 represent a perspective view of a system that includes a power source and an LCC. The system may be an integrated powertrain control system or another electronic system as previously described. The LCC comprises a power source, a collector, an LCC structure, an insert molded piece of plastic or metal, and a reflector. To avoid obstructions in the travel path of a light signal, a method of redirecting the light signal is preferably implemented into the substrate to bypass obstructions along its path. A plastic or metal insert with reflective surface properties at desired angles may be molded inside the substrate at appropriate locations to direct the light signal to specific locations.

FIG. 2 shows a scheme for splitting and directing a light signal in various directions. For certain applications, a diverging or diffusing element may be used so an output signal can propagate through a large volume of the substrate such as an LCC. If a relatively narrow beam is used, such as a focused laser beam, a diffuser may be placed between a light source and the substrate. An element or component through which the light signal enters the substrate may be made coarse so it may function as a diffuser for dispersing the light signal. By the same principle, the light signal can be directed and redirected using a rough surface elsewhere within the substrate so that multidirectional signal transmission can be achieved.

FIG. 3 depicts a power distribution system that includes an Integrated Powertrain Control System (IPCS). For a given obstruction in a layer of the substrate, the directional splitter will direct a light signal using a molded piece of material such as plastic, metal, or a rough surface to diffuse the light signal to avoid the obstacle in the original path of the light signal. Further, molded-in reflectors may be used so the light signal can be further redirected to a desired position or location.

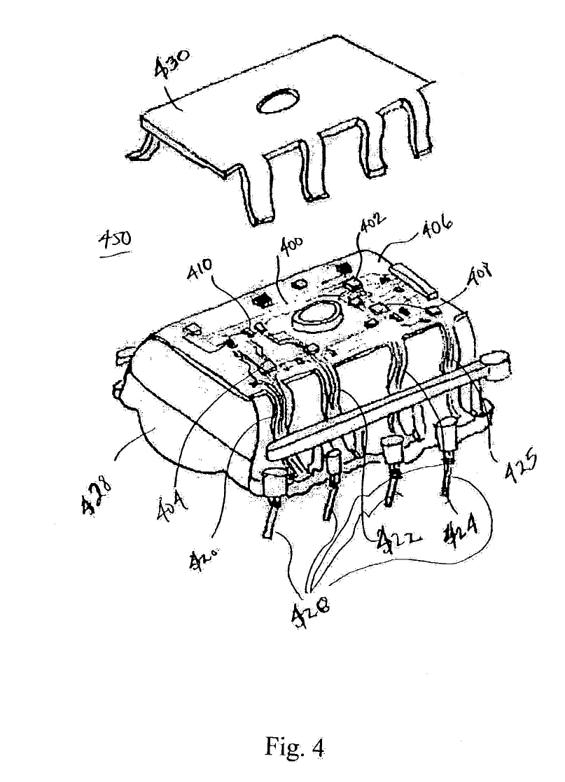

FIG. 4 is a perspective view of an electronic system 450 that includes power sources 402, 404 and an LCC structure 406. The electronic system 450 may be an integrated power train control system or another electronic system. The electronic system 450 preferably has a base 428 and a cover 430. The electronic system 450 preferably comprises power sources 402, 404, an LCC structure 406, and sensors or collectors 408 and 410. In one aspect, the LCC structure 406 is disposed across and may be incorporated with the base 428. The power sources 402, 404 and sensors 408, 410 are linked by wires 420, 422, 424, 426 to pin connections 428, which connect to other components (not shown). In one aspect of the invention, the power sources 402, 404 transmit signals in response to an input signal from the pin connections 428. Preferably, the sensors 408, 410, 412 transmit an output signal to the pin connections 428 in response to the signals from the power sources 402, 404.

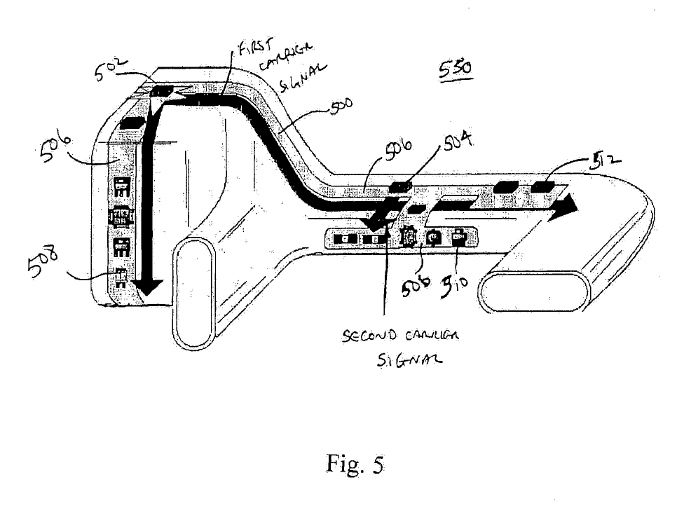

FIG. 5 represents a cutaway view of an electronic system 550 that includes at least two power sources 502, 504 and an LCC structure 506. The electronic system 550 may be an automotive control panel or another electrical system as previously discussed. The electronic system 550 includes a first power source 502, a second power source 504, an LCC structure 506, a first sensor 508, a second sensor 510, and a third sensor 512. The first power source 502 sends a first signal to the first sensor 508 and the third sensor 512. The second power source 504 sends a second signal to the second sensor 510. The first and second signals may have the same or different frequencies.

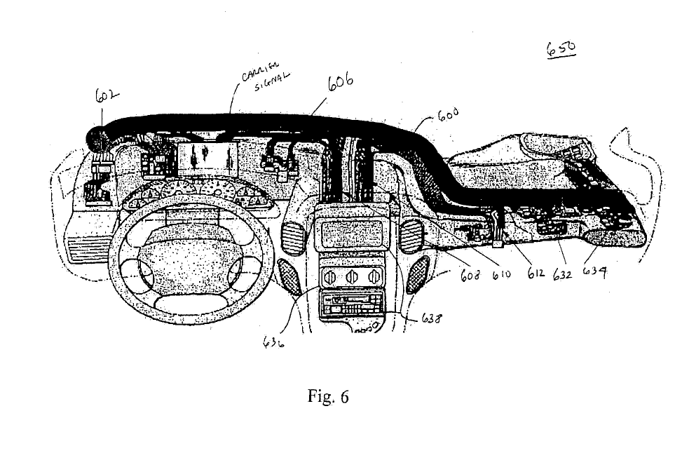

FIG. 6 represents a perspective view of an electronic system 650 that includes a power source 602 and an LCC structure 606. The electronic system 650 may be an automotive control panel or another electrical system as previously discussed. The system includes a power source 602, an LCC structure 606, a first sensor 608, a second sensor 610, a third sensor 612, a fourth sensor 632, and a fifth sensor 634. The power source 602 sends a signal in response to an input signal from a central processing unit (not shown). The signal passes through the LCC structure 606 to the sensors 608, 610, 612, 632, 634. The first sensor 608 sends a first output signal to an external electrical device such as an environmental control device 636. The second sensor 610 sends a second output signal to another external electrical device such as an audio control device 638. Similarly, the third 612, fourth 632, and fifth 634 sensors send output signals to other external electronic devices. The signal may be coded or modulated.

Various embodiments of the invention have been described and illustrated. However, the description and illustrations are by way of example only. Other embodiments and implementations are possible within the scope of this invention and will be apparent to those of ordinary skill in the art. Therefore, the invention is not limited to the specific details, representative embodiments, and illustrated examples in this description. Accordingly, the invention is not to be restricted except in light as necessitated by the accompanying claims and their equivalents.

1. A power distribution system comprising:
a power source;
at least one sensor that receives energy from the power source;
an LCC structure that transmits the energy from the power source to the at least one sensor; and
at least one routing means for directing the energy along the LCC structure from the power source to the at least one sensor.

2. The power distribution system of claim 1, wherein the LCC structure comprises a polymer.

3. The power distribution system of claim 1, wherein the LCC structure comprises a material selected from a group consisting of polybutylene terephthalate, polyethylene terephthalate, polypropylene, polyethylene, silica, and polycarbonate.

4. The power distribution system of claim 1, wherein the power source is selected from a group consisting of light-emitting diode, infrared light source, visible light source, ultraviolet light source, and a radiofrequency source.

5. The power distribution system of claim 1, wherein the at least one sensor comprise a photodetector.

6. The power distribution system of claim 1, wherein the at least one sensor comprises an energy storage device.

7. The power distribution system of claim 1, wherein the at least one sensor comprise a means for requesting additional power from the power source when the at least one sensor begins to run low on power.

8. The power distribution system of claim 1, wherein the at least one sensor is connected to an LCC bus.

9. The power distribution system of claim 8, wherein the LCC bus is connected to an electronic system.

10. The power distribution system of claim 9, wherein the electronic system is a process control system or an instrument panel display.

11. The power distribution system of claim 1, wherein the power source comprise photovoltaic receptors.

12. A power distribution system comprising:
a power source;
at least one sensor that receives energy from the power source;
an LCC structure comprising a polymer, which transmits the energy from the power source to the at least one sensor; and
at least one routing means for directing the energy through the LCC structure from the power source to the at least one sensor;
wherein the at least one sensor is connected to an LCC bus which is connected to an electronic system.

13. The power distribution system of claim 12, wherein the at least one sensor is connected to an LCC bus.

14. The power distribution system of claim 13, wherein the LCC bus is connected to an electronic system.

15. A power distribution system comprising:
a power source;
at least one sensor that receives energy from the power source;
an LCC structure that transmits the energy from the power source to the at least one sensor;
at least one routing means for directing the energy through the LCC structure from the power source to the at least one sensor; and
an energy storage means for storing the energy received by the at least one sensor;
wherein the at least one sensor is connected to an LCC bus which is connected to an electronic system.

16. The power distribution system of claim 15, wherein the at least one sensor is connected to an LCC bus.

17. The power distribution system of claim 16, wherein the LCC bus is connected to an electronic system.

18. A method for distributing power comprising:
transmitting energy using a power source;
directing the energy through an LCC structure from the power source to at least one sensor using at least one routing means; and
receiving the energy from the power source using the at least one sensor.

19. A method for distributing power comprising:
transmitting energy using a power source;
directing the energy through an LCC structure from the power source to at least one sensor using at least one routing means; and
receiving the energy from the power source using the at least one sensor;
wherein the at least one sensor is connected to an LCC bus which is connected to an electronic system.

20. A method for distributing power comprising:
transmitting energy using a power source;
directing the energy through an LCC structure from the power source to at least one sensor using at least one routing means;
using the at least one sensor to receive the energy from the power source that propagates through the LCC structure; and
storing the energy received by the at least one sensor using an energy-storage means;
wherein the at least one sensor is connected to an LCC bus which is connected to an electronic system.
